(19) United States
(12) Patent Application Publication
(10) Pub. No.: US 2023/0314008 A1
(43) Pub. Date: Oct. 5, 2023

(54) GRILL PLATE FOR OVEN WITH SLIDE LOCKING FEATURES

(71) Applicant: Sunbeam Products, Inc., Boca Raton, FL (US)

(72) Inventors: Daniel Sumser, Lake Worth, FL (US); Joseph Maikisch, Palm Beach Gardens, FL (US); Sam Ho, Kowloon Bay (HK); Wai-Shun Chan, Kowloon (HK)

(21) Appl. No.: 18/194,291

(22) Filed: Mar. 31, 2023

Related U.S. Application Data
(60) Provisional application No. 63/326,455, filed on Apr. 1, 2022.

(51) Int. Cl. F24C 15/18

(52) U.S. Cl. CPC F24C 15/18

(57) ABSTRACT

A grill plate is provided that includes a top cooking surface and a bottom surface configured to rest on the wire rack in a countertop oven when the grill plate is in use. The bottom surface of the grill plate may include one or more projections configured to abut tines of the wire rack and limit movement of the grill plate relative to the wire rack in a forward and rearward and a side-to-side direction.

### CROSS-REFERENCE TO RELATED APPLICATIONS

This application claims priority to U.S. Provisional Patent Application Ser. No. 63/326,455, filed on Apr. 1, 2022, entitled “GRILL PLATE FOR OVEN WITH SLIDE LOCKING FEATURES,” currently pending, the entire disclosure of which is incorporated herein by reference.

### FIELD OF THE INVENTION

The present invention relates generally to a grill plate for use in an oven. More particularly, the invention relates to a grill plate that can be placed on a wire rack in an oven such that it is secured in a specific position on the wire rack while in the oven, even when the wire rack is slid into, or from, the oven.

### BACKGROUND OF THE INVENTION

Grill plates are frequently used in countertop ovens. The grill plates may be provided with either substantially flat or grill-like raised cooking surfaces. When the grill plate is in an oven, heat generated within the oven may heat up the grill plate such that food placed on the grill plate is heated primarily via direct heat transferred from the heated grill plate. In this manner, the grill plate operates to cook food similarly to a grill, or a griddle.

However, existing grill plates are not easily secured to the same position on the wire rack when in use, which creates problems for users. First, the grill plates can be inadvertently positioned such that heating elements provided in the oven are not properly located below the grill plate. If the grill plate is not properly positioned above the heating elements, heat may be diverted such that it is not directly provided to the grill. When this happens, additional heated air may contact the food being cooked from above, like in traditional oven cooking. This is undesirable when a user is trying to cook in a grill-style and not the oven-style that air approaching the food from above can provide.

Second, when a user slides out a wire rack on which the grill plate is resting to remove or otherwise inspect the food being cooked, the laws of motion can cause the grill plate to stay in its position when the wire rack is pulled outwardly. This may cause dangerous sloshing in the grill plate. Grease or other food sloshing around in the grill plate, or even worse spilling from the grill plate, can damage the oven or injure a user.

The same sloshing issue can present itself when introducing a grill plate to the wire rack and subsequently pushing the wire rack (with the grill plate thereon) into the oven. Furthermore, if the grill plate is stranded near the rear of the oven when the wire rack is pulled out, he or she is at greater risk of burning his or her hand when reaching into the oven to handle the food, for example when using a spatula.

Attempted solutions to the aforementioned issues that are currently on the market include a grill plate that slides directly into the rack rails already built into the oven for receiving the wire racks. However, it requires the grill plate to be a specific size, possibly larger than necessary in width direction. To ensure the grill plate is placed in the same location, it similarly requires the plate to be the full depth of the oven. Such dimensions in the width and depth direction often makes for a grill plate that is larger than necessary.

Existing ovens also have rack stops on side walls that prevent pulling the wire rack out too far, thereby preventing tipping. However, an additional rack stop for the grill plate would need to be designed for the die-cast grill plate, thus introducing new parts to the oven. This can make its design more complicated and more costly.

Thus, a solution is desired whereby a grill plate is releasably securable to a wire rack in an oven using a simple, repeatable process. The solution should be simple and not involve additional parts.

### SUMMARY OF THE INVENTION

The present invention provides a grill plate having a top surface and a top surface. The top surface includes a raised grill-like surface (like a grill) or a flat surface (like a plancha or a griddle) on which food can be cooked. The bottom surface, which sits on a wire rack of an oven when in use, includes projections that project downwardly from the bottom surface. The projections may be sized and shaped to secure the grill plate to the wire rack when the wire rack is slid inwardly into the oven or outwardly from the oven.

More particularly, the projections may be positioned on the bottom surface of the grill plate such that they abut or otherwise engage length- and width-wise tines of the wire rack. The projections prevent translation in the forward and rearward directions, as well as the side-to-side direction, even when the wire rack is tipped to 45 degrees or more.

### BRIEF DESCRIPTION OF THE DRAWINGS

For a better understanding of the present invention, reference may be made to the following accompanying drawings.

FIG. 1 is a top perspective view of a grill plate constructed according to the teachings hereof.

FIG. 2 is a bottom plan view of the grill plate of FIG. 1.

FIG. 3 is a bottom perspective view of a second embodiment of the grill plate engaged with a wire rack of an oven.

FIG. 4 is a perspective view of the second embodiment of the grill plate of FIG. 3.

### DETAILED DESCRIPTION OF THE INVENTION

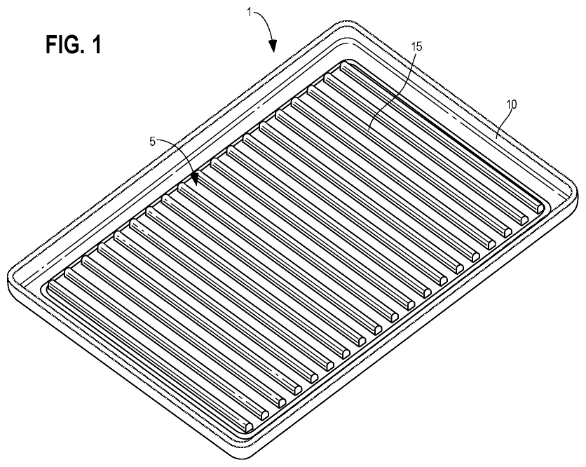

A first embodiment of a grill plate 1 and a top surface 5 thereof is illustrated in FIG. 1.

The grill plate 1 preferably includes sidewalls 10 that may surround its perimeter aimed to reduce the likelihood of food or cooking byproducts like grease contained therein from sloshing over the sidewalls 10. In certain embodiments, the grill plate 1 weighs at least 1.5 lbs, and in certain embodiments it is at least about 2 lbs or at least 500 grams, or at least 800 grams. Typically, the grill plate is made of cast metal such as cast aluminum or cast iron. The grill plate 1 also may include raised ridges 15 that can reproduce grill marks on food being cooked, though such ridges may be absent when a griddle is desirable instead of a grill. The grill plate of FIG. 1 is generally rectangular and sized to fit in a countertop oven, though a nearly limitless number of sizes and configurations are foreseeable.

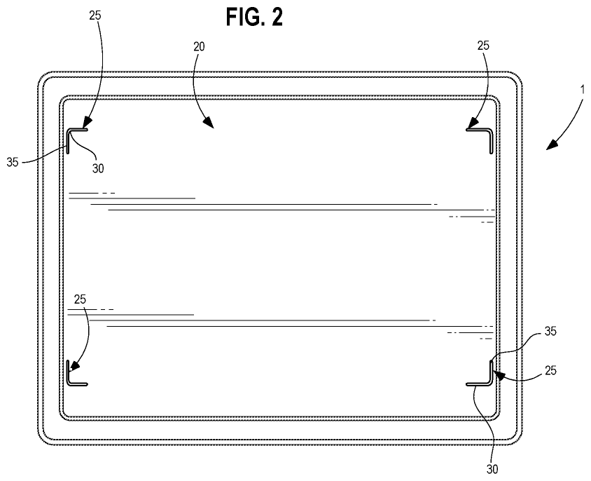

FIG. 2 illustrates a bottom surface 20 of the grill plate 1. The bottom surface 20 is preferably substantially flat such that it can sit level on wire racks provided in ovens. However, unlike existing grill plates, the bottom surface 20 of the grill plate 1 includes a plurality of projections 25 that project outwardly from the bottom surface 20 such that the projections 25 project downwardly when the grill plate 1 is sitting on an oven's wire rack. In some embodiments, the bottom surface 20 includes at least three projections 25. In some embodiments, when at least one projection 25 is towards an end of the grill plate 1 and at least one other projection 25 is offset towards the middle of the plate 1. In certain embodiments, the plate 1 includes at least two projections 25 near an end (near being no more than 20% or no more than 10% of the distance of the length of the plate 25) and at least one projection 25 offset towards the center of the plate 1.

The projections 25 may take on several sizes and shapes including specifically “L” and “T” shaped, but the projections 25 of FIG. 2 are generally L-shaped. The L-shaped projections 25 may include each of a first arm member 30 and a second arm member 35 that abut one another at a vertex to form the L-shape. In alternative embodiments, the arm members 30, 35 may not abut one another and may also vary in length. As set forth below, the projections 25 are preferably sized, shaped, and located to abut tines of the wire rack that run from side to side and/or from front to back. In some embodiments, the projections 25 extend (at least 5 mm, but no more than 15 mm, or between 6-12 mm or about 8-10 mm) from the base of the grill plate 1. In some embodiments, each “leg” of an L-shaped projection 25 is between 10-30 mm long, or more typically about 10-20 mm long.

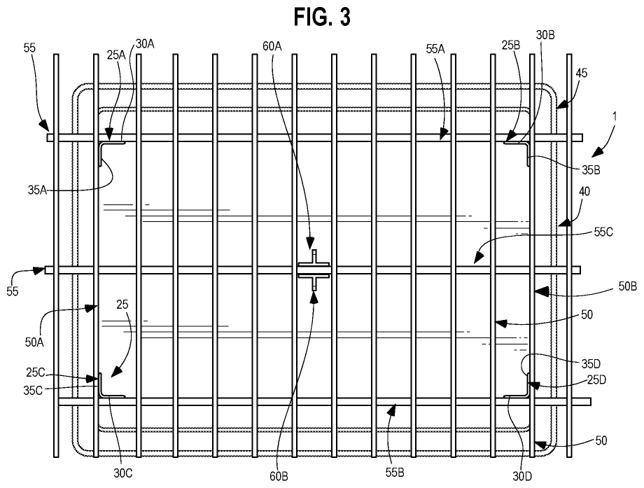

FIG. 3 illustrates a second embodiment of a grill plate, grill plate 40, with its projections 25 engaged with a wire rack 45. The wire rack 45 includes a plurality of first tines 50 running from front to back and a plurality of second tines 55 running from side to side. Other wire racks 45 of varying sizes and shapes are also envisioned and contemplated by the invention.

In the embodiment illustrated herein, to limit movement of the grill plate 40 relative to the wire rack 45 in a rearward direction, first arm member 30A of projection 25A abuts second tine 55A, and first arm member 30B of projection 25B also abuts the second tine 55A. Thus rearward movement of the grill plate 40 is limited by the abutment of arm members 30A, 30B with the second tine 55A. In the forward direction, movement of the grill plate 40 is limited by the first arm member 30C of projection 25C abutting second tine 55B, and first arm member 30D of projection 25D also abutting the second tine 55B.

In the lateral direction, movement in a first direction is limited by second arm 35A of the projection 25A and second arm 35C of the projection 25C each abutting first tine 50A. In a second direction opposite the first direction, movement is limited by second arm 35B of the projection 25B and second arm 35D of the projection 25D each abutting first tine 50B. By being secured to the wire rack 45, the grill plate 40 (or the grill plate 1) is less susceptible to moving relative to the wire rack 45 when it is inserted into or removed from an oven (not illustrated). Further, if the oven or the wire rack 45 is tilted, the grill plate 40 (or the grill plate 1) may be prevented from sliding off the wire rack 45.

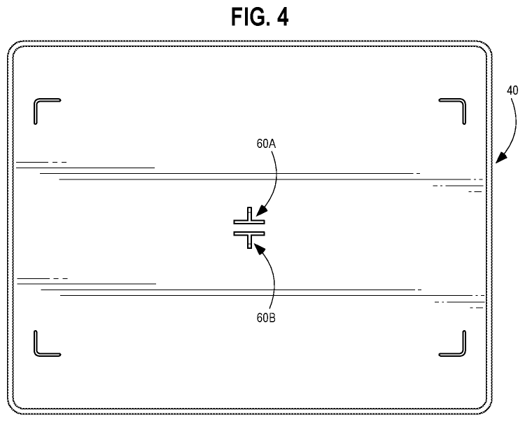

The principal difference between the grill plate 1 and the grill plate 40 is that in addition to the projections 25, the grill plate 40 includes two opposing center projections 60A, 60B (illustrated with the wire rack 45 disengaged from the grill plate 40 in FIG. 4) that engage a second tine 55C between the second tines 55A, 55B. The center projections 60A may act to engage the grill plate 40 even more securely to the wire rack 45. The projections 60A, 60B are not required components of a grill plate such as those disclosed herein.

In alternative embodiments, more or fewer projections 25 may be provided on the bottom surface 20. The projections included in alternative embodiments may also take on several different sizes and shapes. In various embodiments, enough projections should be provided, and in an appropriate configuration, to limit movement of the plate 1, 40, or alternative plates, relative to the rack 45. For example, in one alternative embodiment, a single rectangular projection could be provided by a rectangle formed by adjacent tines 50, 55. The projections should limit at least one of forward to rearward and side to side movement of the grill plate relative to the wire rack. This example is just illustrative of many different alternative constructions available herein.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles, and scope of the present invention.

Many changes, modifications, variations, and other uses and applications of the present invention will, however, become apparent to those skilled in the art after considering the specification and the accompanying drawings. All such changes, modifications, variations, and other uses and applications which do not depart from the spirit and scope of the invention are deemed to be covered by the invention, which is limited only by the claims which follow.

1. A grill plate configured for engagement with a support element in an oven, the grill plate comprising:
a top cooking surface; and
a bottom surface, the bottom surface including one or more projections configured to abut the support element.

2. The grill plate of claim 1, wherein the grill plate includes one or more sidewalls that project upwardly and surround at least a portion of the top cooking surface.

3. The grill plate of claim 1, wherein the top cooking surface includes raised ridges on which food can cook to create grill-like marks on the food.

4. The grill plate of claim 1, wherein the support element is a wire rack, and the one or more projections are configured to selectively mate with the wire rack.

5. The grill plate of claim 1, wherein the grill plate includes at least three projections.

6. The grill plate of claim 1, wherein at least one of the one or more projections is located at or near an end of the grill plate.

7. The grill plate of claim 1, wherein the one or more projections are L-shaped.

8. The grill plate of claim 7, wherein each leg of the one or more projections is between 10 and 30 mm long.

9. The grill plate of claim 1, wherein at least one of the one or more projections is located at or near a center portion of the grill plate.

10. The grill plate of claim 9, wherein at least one of the one or more projections is T-shaped.

11. A grill plate configured for selective engagement with a wire rack in an oven, the grill plate comprising:
a first surface on which food may be cooked when the grill plate is in the oven; and
a second surface configured to sit on the wire rack when the grill plate is in the oven, the second surface including at least one projection that engages a portion of the wire rack when the grill plate is placed on the wire rack.

12. The grill plate of claim 11, wherein the grill plate includes one or more sidewalls that project upwardly and surround at least a portion of the first surface.

13. The grill plate of claim 11, wherein the first surface includes raised ridges on which food can cook to create grill-like marks on the food.

14. The grill plate of claim 11, wherein the wire rack includes a plurality of first tines running in a first direction and a plurality of second tines running in a second direction, and wherein the first direction and the second direction are substantially perpendicular to one another.

15. The grill plate of claim 11, wherein the grill plate includes at least three projections.

16. The grill plate of claim 11, wherein the at least one projection is located at or near an end of the grill plate.

17. The grill plate of claim 11, the at least one projection is L-shaped.

18. The grill plate of claim 17, wherein each leg of the at least one projection is between 10 and 30 mm long.

19. The grill plate of claim 11, wherein the at least one projection is located at or near a center portion of the grill plate.

20. The grill plate of claim 19, wherein the at least one projection is T-shaped.
